(19) United States
(12) Patent Application Publication
(10) Pub. No.: US 2025/0298334 A1
(43) Pub. Date: Sep. 25, 2025

(54) IMAGE FORMING SYSTEM, DEVELOPER REPLACEMENT METHOD, AND CLEANING DEVELOPER ACCOMMODATION PORTION

(71) Applicant: FUJIFILM Business Innovation Corp., Tokyo (JP)

(72) Inventors: Shinya MAKIURA, Kanagawa (JP); Shingo OHIRA, Kanagawa (JP); Taiyou UEHARA, Kanagawa (JP)

(73) Assignee: FUJIFILM Business Innovation Corp., Tokyo (JP)

(21) Appl. No.: 18/820,326

(22) Filed: Aug. 30, 2024

(30) Foreign Application Priority Data
Mar. 25, 2024 (JP) 2024-048753

(51) Int. Cl. G03G 15/01; G03G 15/02; G03G 15/08; G03G 15/095; G03G 21/00

(52) U.S. Cl. CPC G03G 15/0121; G03G 15/0115; G03G 15/0189; G03G 15/0216; G03G 15/0865; G03G 15/095; G03G 21/0011; G03G 21/0035; G03G 2215/0607

(57) ABSTRACT

An image forming system includes plural photoreceptors with surfaces on which electrostatic latent images attributable to a difference in charging potential are formed, plural development devices that are provided to face the photoreceptors, that respectively accommodate toners of different colors, and that develop the electrostatic latent images by means of the toners, plural developer accommodation portions that accommodate developers of different colors each of which contains a toner of a normal color, which is any one of yellow, magenta, cyan, or black, or a toner of a special color other than the normal color and a carrier, plural supply paths through which the developers from the developer accommodation portions are respectively supplied to the development devices, and at least one processor configured to execute a discharge mode in which, in a case where a cleaning developer accommodation portion accommodating a cleaning developer that is a replacement and that contains a toner of a new color and a larger number of carriers than a usual number of carriers is attached to a supply path, the cleaning developer is supplied so that a developer before replacement that is in the supply path and a development device is discharged, and a switch mode in which the developer in the supply path and the development device is switched with the cleaning developer.

### CROSS-REFERENCE TO RELATED APPLICATIONS

This application is based on and claims priority under 35 USC 119 from Japanese Patent Application No. 2024-048753 filed Mar. 25, 2024.

### BACKGROUND

### (i) Technical Field

The present disclosure relates to an image forming system, a developer replacement method, and a cleaning developer accommodation portion.

### (ii) Related Art

Disclosed in JP2006-106692A is an image forming apparatus in which a plurality of types of cartridges each including a plurality of process members used for image formation and a storage medium that stores information are attachable and detachable and the image forming apparatus includes a storage unit that stores a plurality of pieces of setting information used to set image forming conditions in accordance with a plurality of characteristics of the cartridges and a control unit that sets the image forming conditions based on information related to the amount of use of each of the plurality of types of cartridges and information for selection of the setting information stored in the storage mediums of the cartridges.

### SUMMARY

Aspects of non-limiting embodiments of the present disclosure relate to an image forming system, a developer replacement method, and a cleaning developer accommodation portion with which it is not necessary to replace, as a member other than a developer accommodation portion, at least a supply path and a development device in a case where the developer accommodation portion is to be replaced with another developer accommodation portion accommodating a developer having a different color.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a plurality of photoreceptors with surfaces on which electrostatic latent images attributable to a difference in charging potential are formed, a plurality of development devices that are provided to face the photoreceptors, that respectively accommodate toners of different colors, and that develop the electrostatic latent images by means of the toners, a plurality of developer accommodation portions that accommodate developers of different colors each of which contains a toner of a normal color, which is any one of yellow, magenta, cyan, or black, or a toner of a special color other than the normal color and a carrier, a plurality of supply paths through which the developers from the developer accommodation portions are respectively supplied to the development devices, and at least one processor configured to execute a discharge mode in which, in a case where a cleaning developer accommodation portion accommodating a cleaning developer that is a replacement and that contains a toner of a new color and a larger number of carriers than a usual number of carriers is attached to a supply path, the cleaning developer is supplied so that a developer before replacement that is in the supply path and a development device is discharged, and a switch mode in which the developer in the supply path and the development device is switched with the cleaning developer.

### BRIEF DESCRIPTION OF THE DRAWINGS

Exemplary embodiment(s) of the present invention will be described in detail based on the following figures, wherein:

FIG. 1 is a schematic view showing a configuration of an image forming system according to a first exemplary embodiment as seen from a front side;

FIG. 2 is a schematic configuration view showing a development device used in the image forming system according to the first exemplary embodiment;

FIG. 3 is a schematic configuration view showing a developer cartridge and a supply path used in the image forming system according to the first exemplary embodiment;

FIG. 4 is a block diagram showing a hardware configuration of the image forming system according to the first exemplary embodiment;

FIG. 5 is a configuration diagram showing an example of replacement of a developer cartridge containing a toner of a special color with a developer cartridge containing a toner of another special color, which is a replacement, in the image forming system according to the first exemplary embodiment;

FIG. 6 is a process drawing showing an example of a developer replacement method in the image forming system according to the first exemplary embodiment;

FIG. 7 is a configuration diagram showing an example of the order in which developer cartridges are attached to the supply path in the image forming system according to the first exemplary embodiment;

FIG. 8 is a diagram showing an example of a toner image formed on a surface of a photoreceptor in a discharge mode in the image forming system according to the first exemplary embodiment; and

FIG. 9 is a flowchart showing the flow of processing in the image forming system according to the first exemplary embodiment.

### DETAILED DESCRIPTION

An example of an exemplary embodiment according to the present invention will be described below with reference to the drawings. In the following description, a direction denoted by an arrow X in the drawing will be referred to as an apparatus width direction and a direction denoted by an arrow Y will be referred to as an apparatus height direction. In addition, a direction (a direction along an arrow Z) orthogonal to the apparatus width direction and the apparatus height direction will be referred to as an apparatus depth direction.

### First Exemplary Embodiment

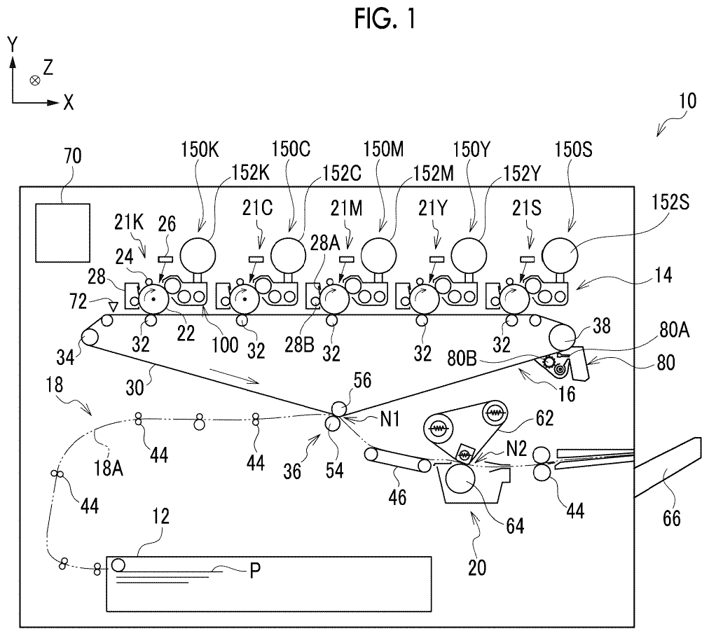

FIG. 1 shows an image forming system 10 according to a first exemplary embodiment. First, the image forming system 10 (refer to FIG. 1) according to the first exemplary embodiment will be described. Next, a development device 100 and developer supply devices 150 will be described.

### Overall Configuration of Image Forming System

As shown in FIG. 1, the image forming system 10 is an electrophotographic apparatus configured to include a recording medium accommodation portion 12, a toner image forming unit 14, a transfer device 16, a recording medium transport device 18, a fixing device 20, and a control unit 70.

The recording medium accommodation portion 12 has a function of accommodating a paper sheet P which is an example of a recording medium. Although not shown, the recording medium accommodation portion 12 may be configured to include a plurality of accommodation portions accommodating a plurality of types of paper sheets P.

The toner image forming unit 14 has a function of forming, through a charging step, an exposure step, and a development step, a toner image that is held by an intermediate transfer belt 30 (which will be described later) constituting the transfer device 16. For example, the toner image forming unit 14 includes single-color units 21Y, 21M, 21C, 21K, and 21S that form toner images on respective photoreceptors 22 by using toners having different colors (yellow (Y), magenta (M), cyan (C), black (K), and a special color(S)). In addition, the toner image forming unit 14 is able to form a toner image having a plurality of colors, for example, in accordance with image data. The toners of yellow (Y), magenta (M), cyan (C), and black (K) are examples of a normal-color toner. The toner of the special color(S) is an example of toner of a special color, and is toner of a color other than yellow (Y), magenta (M), cyan (C), and black (K). As the toner of the special color(S), for example, white (W) toner, clear (CR (transparent)) toner, gold toner, silver toner, or the like is used.

The single-color units 21Y, 21M, 21C, 21K, and 21S have the same configurations as each other except for colors of toner images formed by the respective single-color units. In the following description, in a case where it is not necessary to distinguish the single-color units 21Y, 21M, 21C, 21K, and 21S and components thereof from each other, the description will be made with alphabets (Y, M, C, K, and S) of the single-color units 21Y, 21M, 21C, 21K, and 21S omitted. Each single-color unit 21 includes a photoreceptor 22, a charging roll 24, an exposure device 26, a development device 100, and a cleaning device 28.

The charging roll 24 charges a surface of the photoreceptor 22 by applying a voltage obtained by superimposing an AC voltage on a DC voltage. The charging roll 24 is disposed upstream of the development device 100 in a rotation direction of the photoreceptor 22 which is represented by an arrow. In addition, the cleaning device 28 includes a cleaning blade 28A that comes into contact with the surface of the photoreceptor 22 and a cleaning brush 28B that comes into contact with the surface of the photoreceptor 22 at a position upstream of the cleaning blade 28A. The cleaning blade 28A and the cleaning brush 28B are examples of a cleaning member. The cleaning device 28 is disposed downstream of a toner image transfer position in the rotation direction of the photoreceptor 22. Toner remaining on the surface of the photoreceptor 22 is removed by the cleaning blade 28A and the cleaning brush 28B.

The transfer device 16 has a function of holding toner images of respective colors that are formed by the respective single-color units 21 and transferring the toner images to the paper sheet P that is transported. The transfer device 16 includes an intermediate transfer belt 30, five transfer rolls 32, a drive roll 38, a secondary transfer unit 36, a tension roll 34, and a cleaning device 80. The intermediate transfer belt 30 has an endless shape. The five transfer rolls 32 and the respective photoreceptors 22 form nips with the intermediate transfer belt 30 interposed therebetween. The intermediate transfer belt 30 is caused to revolve in a direction along an arrow by the drive roll 38. For example, the single-color units 21S, 21Y, 21M, 21C, and 21K are disposed in this order from an upstream side to a downstream side in a revolution direction of the intermediate transfer belt 30. Accordingly, toner images on the photoreceptors 22 that are formed by the single-color units 21S, 21Y, 21M, 21C, and 21K are transferred to the intermediate transfer belt 30 by the transfer rolls 32 while being superimposed onto each other.

The secondary transfer unit 36 includes a transfer roll 54 that comes into contact with a surface of the intermediate transfer belt 30 on which a toner image is held, and a facing roll 56 that is disposed to face the transfer roll 54 with the intermediate transfer belt 30 interposed therebetween. At the secondary transfer unit 36, toner images of respective colors held on the intermediate transfer belt 30 are transferred to the paper sheet P being transported. The cleaning device 80 is disposed downstream of the secondary transfer unit 36 in the revolution direction of the intermediate transfer belt 30. The cleaning device 80 includes a cleaning blade 80A and a cleaning brush 80B that come into contact with the intermediate transfer belt 30. The cleaning blade 80A and the cleaning brush 80B remove toner remaining on the intermediate transfer belt 30.

The recording medium transport device 18 has a function of transporting the paper sheet P such that the paper sheet P passes through a nip N1 of the secondary transfer unit 36 and a nip N2 of the fixing device 20. The recording medium transport device 18 includes a plurality of transport rolls 44 and a transport belt 46. Each transport roll 44 is composed of a pair of rolls. The transport rolls 44 transport the paper sheet P accommodated in the recording medium accommodation portion 12, along a transport path 18A.

The transport belt 46 has a configuration in which an endless belt is wound around a pair of rolls disposed to be separated from each other. The transport belt 46 is disposed downstream of the secondary transfer unit 36 and upstream of the fixing device 20 in a transport direction of the paper sheet P. The transport belt 46 transports, to the fixing device 50 along the transport path 18A, the paper sheet P on which toner images have been transferred at the secondary transfer unit 36.

The fixing device 20 has a function of fixing, at the nip N2, toner images that are transferred (secondary-transferred) onto the paper sheet P by the transfer device 16. The fixing device 20 includes a heating unit 62 at which an endless belt revolves and a pressing roll 64 that comes into pressure-contact with the heating unit 62. In a case where the paper sheet P is transported to the nip N2 between the heating unit 62 and the pressing roll 64, a toner image on the paper sheet P is fixed by being heated and pressed.

The control unit 70 has a function of controlling each unit of the image forming system 10. For example, the control unit 70 controls each unit of the image forming system 10 (causes each unit to operate) in accordance with image formation data received from an external device (not shown). Here, the image formation data includes image data (image information) used to cause each single-color unit 21 to form a toner image and data necessary for other image forming operations.

In addition, the image forming system 10 includes a density sensor 72 that detects the density of a toner image transferred to the intermediate transfer belt 30, the density sensor 72 being provided downstream of the single-color units 21S, 21Y, 21M, 21C, and 21K in the revolution direction of the intermediate transfer belt 30. For example, the density sensor 72 is a reflective type optical sensor including a light emitting element and a light receiving element.

### Operation of Image Forming System

Next, the operation of the image forming system 10 will be described.

The control unit 70 that receives the image formation data from the external device (not shown) causes the toner image forming unit 14, the transfer device 16, the recording medium transport device 18, and the fixing device 20 to operate. In the toner image forming unit 14, the photoreceptors 22 are respectively charged by the charging rolls 24 and the photoreceptors 22 are respectively exposed to light by the exposure device 26 so that electrostatic latent images attributable to a difference in charging potential are formed on surfaces of the photoreceptors 22. Furthermore, the electrostatic latent images of the photoreceptors 22 are respectively developed as toner images by the development devices 100. As a result, toner images are respectively formed on the photoreceptors 22.

Next, a voltage (a primary transfer voltage) is applied to each transfer roll 32 from a power source (not shown). In addition, the drive roll 38 driven by a drive source (not shown) causes the intermediate transfer belt 30 to revolve in the direction along the arrow. As a result, toner images of respective colors are superimposed onto each other and primary-transferred to the intermediate transfer belt 30.

Furthermore, the recording medium transport device 18 feeds the paper sheet P to the nip N1 in accordance with a time at which the toner images of the respective colors held on the revolving intermediate transfer belt 30 reach the nip N1. At the secondary transfer unit 36, a voltage (a secondary transfer voltage) is applied from a power source (not shown) to a power supply roll (not shown) that comes into contact with an outer periphery of the facing roll 56, so that the toner images of the respective colors are secondary-transferred to the paper sheet P passing through the nip N1.

Next, the recording medium transport device 18 feeds the paper sheet P, onto which the toner images of the respective colors have been secondary-transferred, to the nip N2, so that the toner images of the respective colors are fixed onto the paper sheet P passing through the nip N2 by the fixing device 20 and an image is formed on the paper sheet P. Thereafter, the paper sheet P is discharged to a discharge portion 66 by the transport roll 44.

### Development Device

Next, the development device 100 will be described.

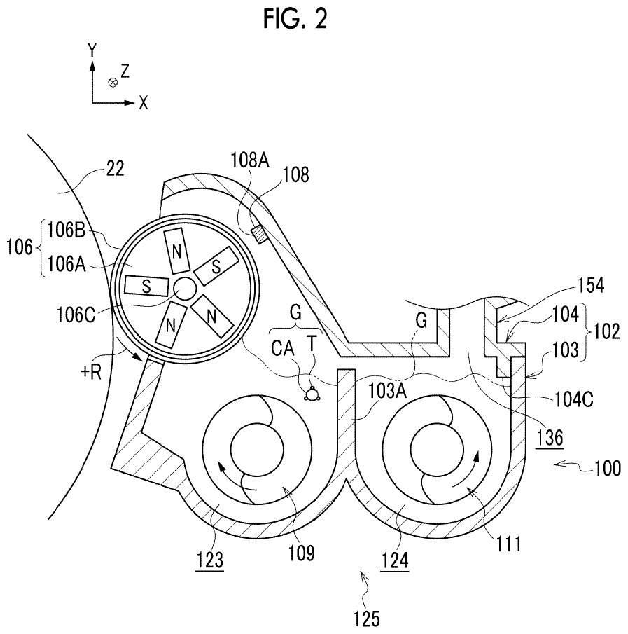

As shown in FIG. 2, the development device 100 is disposed to face the photoreceptor 22. The development device 100 includes a housing 102 in which a developer G is accommodated, a development roll 106 that holds the developer G, a trimmer 108 that restricts the thickness of a layer of the developer G on an outer peripheral surface of the development roll 106, and a developer agitating and transporting unit 125. For example, the developer agitating and transporting unit 125 includes a first agitation and transport chamber 123 and a second agitation and transport chamber 124 adjacent to the first agitation and transport chamber 123. In addition, the first agitation and transport chamber 123 is provided with a first auger 109, and the second agitation and transport chamber 124 is provided with a second auger 111.

As shown in FIG. 2, the developer G is, for example, a two-component developer including toner T which is an example of a charging particle charged to a negative polarity and a carrier CA which is an example of a magnetic particle charged to a positive polarity.

The housing 102 is configured to include a container body 103 and a cover member 104 that blocks an upper portion of the container body 103. The container body 103 includes a partition wall 103A that separates the first agitation and transport chamber 123 and the second agitation and transport chamber 124 from each other. The container body 103 is provided with inlet ports (not shown) that lead to the first agitation and transport chamber 123 and the second agitation and transport chamber 124 at both end portions of the partition wall 103A in a Z direction. In the first agitation and transport chamber 123 and the second agitation and transport chamber 124, the first auger 109 and the second auger 111 are rotated in opposite directions so that the developer G is transported while being agitated.

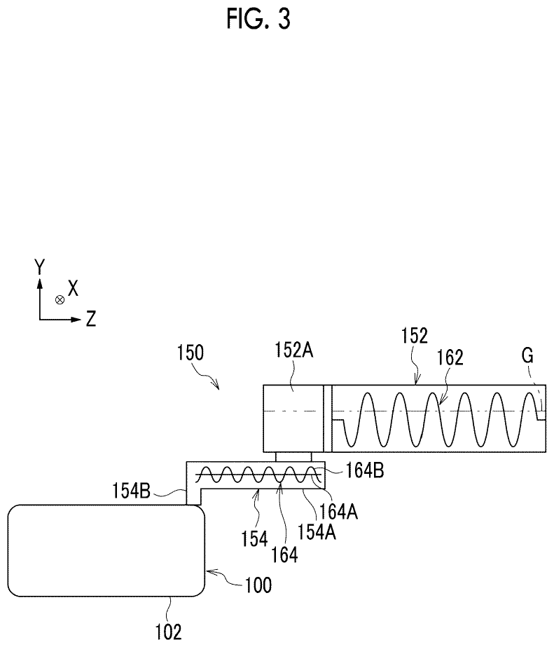

The cover member 104 is provided with a developer supply port 136. For example, the developer supply port 136 is provided above the second agitation and transport chamber 124. A lower end portion of a supply path 154 (refer to FIG. 3) for supply of the new toner T, which will be described below, is connected to the developer supply port 136.

The development roll 106 includes a magnet roll 106A that is fixed to and supported at the container body 103 via a shaft 106C and a cylindrical development sleeve 106B that is supported to be able to revolve outside the magnet roll 106A. The magnet roll 106A is provided with a plurality of magnetic poles along an outer peripheral surface (a circumferential direction).

The developer G in the first agitation and transport chamber 123 is transported in a state of being held on the development sleeve 106B as the development sleeve 106B rotates in a +R direction. In addition, the developer G held on the development sleeve 106B enters a space between an outer peripheral surface of the development sleeve 106B and a distal end portion 108A of the trimmer 108 so that the thickness of a layer is restricted, and the developer G is transported to a development region facing the photoreceptor 22.

Developer Supply Devices Next, the developer supply devices 150 will be described.

As shown in FIG. 1, the image forming system 10 includes developer supply devices 150Y, 150M, 150C, 150K, and 150S that supply, to the development devices 100 of the single-color units 21Y, 21M, 21C, 21K, and 21S, the developers G containing the toners T having different colors (yellow (Y), magenta (M), cyan (C), black (K), and the special color(S)). The developer supply devices 150Y, 150M, 150C, 150K, and 150S include a plurality of developer cartridges 152Y, 152M, 152C, 152K, and 152S that accommodate the developers G containing toners having different colors (yellow (Y), magenta (M), cyan (C), black (K), and the special color(S)). The developers G contain the toners T of the respective colors and the carriers CA. The developer cartridges 152Y, 152M, 152C, 152K, and 152S are examples of a developer accommodation portion.

The developer supply devices 150Y, 150M, 150C, 150K, and 150S have the same configurations as each other except for the color of toner accommodated therein or transported thereto. Hereinafter, regarding the developer supply devices 150Y, 150M, 150C, 150K, and 150S, the alphabets (Y, M, C, K, and S) will be omitted in a case where the colors of the toners do not need to be distinguished from each other.

As shown in FIG. 3, the developer supply device 150 includes the supply path 154 that is connected to a lower portion of a developer cartridge 152. The developer G from the developer cartridge 152 is supplied to the development device 100 through the supply path 154. The supply path 154 includes a tubular lateral transport path 154A connected to the developer cartridge 152 and a tubular vertical transport path 154B connected to an end portion of the lateral transport path 154A that is on a side opposite to the developer cartridge 152.

The developer cartridge 152 has a tubular shape and includes an agitator 162 that transports the developer G inside the developer cartridge 152. For example, the agitator 162 is a spiral member that rotates.

The lateral transport path 154A is disposed along a lateral direction of the image forming system 10, that is, a horizontal direction. An upstream-side end portion of the lateral transport path 154A in a transport direction of the developer G is connected to an end portion 152A of the developer cartridge 152 in an axial direction. Inside the lateral transport path 154A, a transport member 164 that transports the developer G along an axial direction of the lateral transport path 154A is provided.

The transport member 164 includes a rotary shaft 164A disposed along a longitudinal direction (the Z direction) of the lateral transport path 154A, and a spiral transport blade 164B supported at an outer periphery of the rotary shaft 164A. As the rotary shaft 164A rotates, the transport member 164 transports, toward the vertical transport path 154B, the developer G that is introduced into the lateral transport path 154A from the developer cartridge 152.

The vertical transport path 154B is disposed along the vertical direction, and a downstream-side end portion of the vertical transport path 154B in the transport direction of the developer G is connected to the cover member 104 of the development device 100 (refer to FIG. 2). Through the vertical transport path 154B, toner transported from the lateral transport path 154A falls so that the developer G is supplied to the development device 100.

Regarding the developer supply device 150, the developer cartridge 152 is configured to be attachable to and detachable from the supply path 154. For example, in a case where the amount of the developer G in the developer cartridge 152 that contains the toner T of a normal color (yellow (Y), magenta (M), cyan (C), and black (K)) or a special color(S) is small, the developer cartridge 152 can be replaced with a new developer cartridge 152 that contains the toner T of the same color. In this case, the old developer cartridge 152 only needs to be detached from the lateral transport path 154A of the supply path 154, and the new developer cartridge 152 including the toner T of the same color only needs to be attached to the lateral transport path 154A of the supply path 154.

In addition, in the first exemplary embodiment, the developer cartridge 152 containing the toner T of a specific color can be replaced with the developer cartridge 152 containing the toner T of a different color. A case where the developer cartridge 152 containing the toner T having a specific color is replaced with the developer cartridge 152 containing the toner T having a different color will be described later.

### Control Configuration of Image Forming System 10

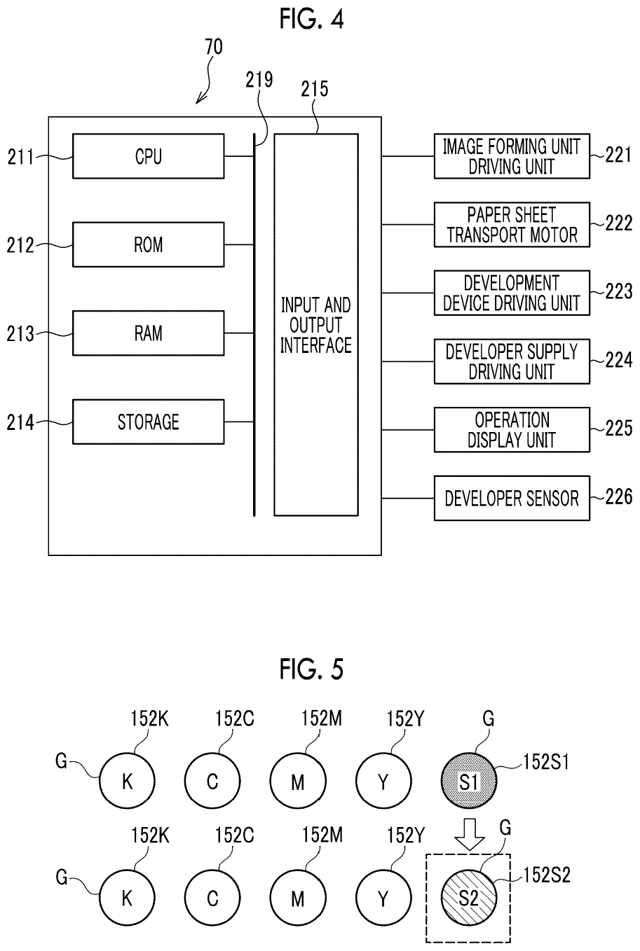

Next, a control configuration, which is the configuration of an electrical system of the image forming system 10, will be described. FIG. 4 is a block diagram showing a hardware configuration of the image forming system 10.

As shown in FIG. 4, the control unit 70 includes a central processing unit (CPU) 211, a read only memory (ROM) 212, a random access memory (RAM) 213, a storage 214, and an input and output interface 215 as components thereof. The components are connected to each other via a bus 219 such that the components can communicate with each other.

The CPU 211 is a central processing unit and executes various programs or controls each unit. The CPU 211 is an example of a processor. The CPU 211 reads out a program from the ROM 212 or the storage 214 and executes the program while using the RAM 213 as a work area. In the present exemplary embodiment, a processing program is stored in the ROM 212 or the storage 214. The CPU 211 controls each component and performs various arithmetic processes according to the processing program recorded on the ROM 212 or the storage 214.

The ROM 212 stores various programs and various types of data. The RAM 213 temporarily stores programs or data as a work area. The storage 214 is composed of a hard disk drive (HDD) or a solid state drive (SSD) and stores various programs including an operating system and various types of data.

The input and output interface 215 is an interface for transmission and reception of information to and from a device in the vicinity of the control unit 70. The input and output interface 215 is connected to each of an image forming unit driving unit 221, a paper sheet transport motor 222, a development device driving unit 223, a developer supply driving unit 224, an operation display unit 225, and a developer sensor 226, and the input and output interface 215 can transmit and receive information to and from each component. Note that, in the image forming system 10 according to the exemplary embodiment of the present disclosure, at least one or more of the image forming unit driving unit 221, the paper sheet transport motor 222, the development device driving unit 223, the developer supply driving unit 224, the operation display unit 225, or the developer sensor 226 may be directly connected via the bus 219 unlike the above-described configuration.

The image forming unit driving unit 221 is connected to each of the single-color units 21 of the toner image forming unit 14 and each unit of the transfer device 16. The image forming unit driving unit 221 receives an instruction from the CPU 211 of the control unit 70 and drives each of the single-color units 21 and each unit of the transfer device 16.

The paper sheet transport motor 222 is connected to the transport rolls 44 and the transport belt 46 via, for example, a driving mechanism such as a gear. The transport rolls 44 rotate and the transport belt 46 revolves as the paper sheet transport motor 222 is driven. The paper sheet transport motor 222 controls transportation of the paper sheet P in accordance with the timing of image formation that is performed by each of the single-color units 21 and the transfer device 16.

The development device driving unit 223 is connected to each unit of the development devices 100. The development device driving unit 223 receives an instruction from the CPU 211 and drives each unit of the development devices 100. For example, the development device driving unit 223 controls rotation of the development rolls 106, the first augers 109, and the second augers 111.

The developer supply driving unit 224 is connected to each unit of the developer supply devices 150. The developer supply driving unit 224 receives an instruction from the CPU 211 and drives each unit of the developer supply devices 150. For example, the developer supply driving unit 224 controls rotation of the agitators 162 of the developer cartridges 152 and rotation of the transport members 164 of the developer supply devices 150 such that the developers G are supplied to the development devices 100.

The operation display unit 225 receives an instruction made by a user of the image forming system 10 and notifies the user of various kinds of information on the situation of operation or the like of the image forming system 10. The operation display unit 225 includes, for example, a touch panel type display, on which a display button for realization of reception of an operation instruction through a program or various kinds of information are displayed, and a hardware key such as a ten key or a start button.

The developer sensor 226 detects information regarding the developers G, such as the colors of the toners T in the developers G inside the development devices 100 and the concentrations of the toners in the developers G. For example, the developer sensor 226 detects the types of the toners T. In the first exemplary embodiment, the developer sensor 226 detects that the developers G inside the development devices 100 have been replaced with a cleaning developer G2 which will be described later. The CPU 211 acquires information regarding the developers G or the cleaning developer G2 detected by the developer sensor 226. For example, the storage 214 stores information regarding the developers G or the cleaning developer G2.

### Replacement of Developer Cartridge

Next, replacement of the developer cartridges 152 in the image forming system 10 will be described.

As shown in FIG. 5, for example, a developer cartridge 152S1 that accommodates the developer G containing the toner T of a first special color (S1) and the carrier CA can be replaced with a developer cartridge 152S2 that accommodates the developer G containing the toner T of a second special color (S2) different from the first special color (S1) and the carrier CA. The toner T of the first special color (S1) is an example of toner having a special color. In addition, the toner T of the second special color (S2) is an example of toner of another special color, and is an example of toner of a new color that is a replacement.

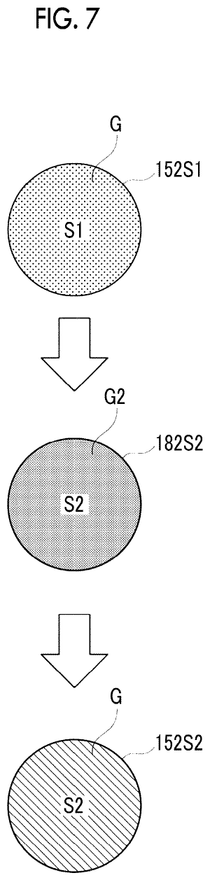

In this case, only the developer cartridge 152S1 is a target to be replaced and the supply path 154, the development device 100, and the photoreceptor 22 are not to be replaced. That is, even in a case where the developer cartridge 152S1 including the toner T of the first special color (S1) is to be replaced with the developer cartridge 152S2 including the toner T of the second special color (S2), the supply path 154, the development device 100, and the photoreceptor 22 are continuously used without being replaced. In this case, the developer cartridge 152S1 is not replaced with the developer cartridge 152S2 directly and a cleaning developer cartridge 182S2, which will be described later, is used between use of the developer cartridge 152S1 and use of the developer cartridge 152S2 (refer to FIG. 7).

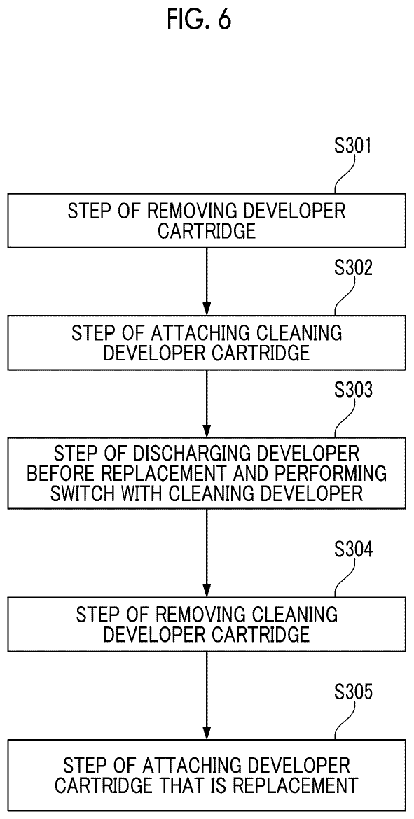

FIG. 6 is a process drawing showing an example of a developer replacement method in the image forming system 10. FIG. 7 is a diagram showing an example of developer cartridges attached to the supply path 154.

As shown in FIG. 6, the developer replacement method includes a step of removing the developer cartridge 152S1 (step S301). Specifically, a user removes, from the supply path 154, the developer cartridge 152S1 that accommodates the developer G containing the toner T of the first special color (S1) and the carrier CA.

In addition, the developer replacement method includes a step of attaching the cleaning developer cartridge 182S2 (step S302). Specifically, the user attaches the cleaning developer cartridge 182S2 shown in FIG. 7 to the supply path 154. The cleaning developer cartridge 182S2 is an example of a cleaning developer accommodation portion. The cleaning developer cartridge 182S2 accommodates the cleaning developer G2 that contains the toner T of the second special color (S2) and a larger number of carriers CA than a usual number of carriers CA. In a state where the developer cartridge 152 is new, the developer cartridge 152 accommodates the developer G containing the toner T of each color and a usual number of carriers CA. That is, the usual number of carriers CA means a number of carriers CA generally contained in the developer G in the new developer cartridge 152. The cleaning developer cartridge 182S2 accommodates, for example, the carriers CA that are equal to or more than two times a usual number of carriers CA in terms of weight ratio. The amount of the toner T may be the same as a usual amount of toner T and the amount of the toner T may be reduced in accordance with the degree of an increase in number of the carriers CA.

Since the cleaning developer G2 that contains the toner T of the second special color (S2) and a larger number of carriers CA than a usual number of carriers CA is used, the toner T of the second special color S2 is likely to be attracted to the carriers CA. Therefore, the cleaning developer G2 is easily supplied.

In addition, the developer replacement method includes a step of discharging the developer G before replacement and performing a switch with the cleaning developer G2 (step S303). Specifically, discharge of the developer G before replacement is performed by means of the cleaning developer G2 of the cleaning developer cartridge 182S2 and a switch with the cleaning developer G2 is performed.

The ROM 212 or the storage 214 of the control unit 70 stores a discharge mode in which the cleaning developer G2 is supplied so that the developer G before replacement that is in the supply path 154 and the development device 100 is discharged. In addition, the ROM 212 or the storage 214 stores a switch mode in which the developer in the supply path 154 and the development device 100 is switched with the cleaning developer G2. For example, in a case where attachment of the cleaning developer cartridge 182S2 to the supply path 154 is detected by a sensor (not shown), the CPU 211 executes the discharge mode and the switch mode. For example, the CPU 211 may progress the discharge mode and the switch mode simultaneously.

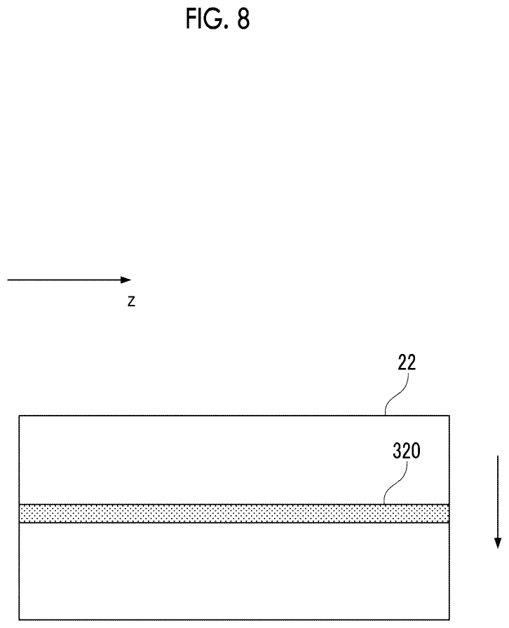

As shown in FIG. 8, the discharge mode includes an operation of causing, with the photoreceptor 22 rotating in a direction along an arrow, the toner T from the development device 100 to adhere to a surface of the photoreceptor 22 to form a toner image 320 and cleaning the surface of the photoreceptor 22 by means of the cleaning blade 28A and the cleaning brush 28B. For example, the toner image 320 is a band-shaped toner image (for example, a toner band) formed on the surface of the photoreceptor 22 along an axial direction (the direction along the arrow Z).

For example, the toner image 320 may be formed up to the outside of an area through which the paper sheet P passes with respect to the photoreceptor 22. In addition, the toner image 320 may be a halftone toner image of which the coverage rate is equal to or greater than 30% and equal to or smaller than 60%. The halftone is a middle-tone image in which the amount of toner is smaller than in the case of a 100% coverage rate image, which is a solid image. For example, regarding the toner image 320, a halftone coverage rate is set to 40% and the photoreceptor 22 is rotated for about 10 minutes, so that toner is discharged.

Accordingly, the cleaning developer G2 is supplied from the cleaning developer cartridge 182S2 and thus the developer G before replacement that is in the supply path 154 and the development device 100 is discharged. Furthermore, the developer in the supply path 154 and the development device 100 is switched with the cleaning developer G2. For example, the developer sensor 226 detects that the developer in the development device 100 has been switched with the cleaning developer G2.

In addition, the developer replacement method includes a step of removing the cleaning developer cartridge 182S2 (step S304). Specifically, the user removes the cleaning developer cartridge 182S2 from the supply path 154. For example, in a case where the developer sensor 226 detects that the developer in the development device 100 has been switched with the cleaning developer G2, the operation display unit 225 may display completion information indicating that a switch with the cleaning developer G2 has been completed. Accordingly, the user can know a time at which the cleaning developer cartridge 182S2 is to be removed.

In addition, the developer replacement method includes a step of attaching the developer cartridge 152S2, which is a replacement (step S305). Specifically, the user attaches, to the supply path 154 the developer cartridge 152S2 shown in FIG. 7, which is the replacement. The developer cartridge 152S2 is an example of a developer accommodation portion that is a replacement. The developer cartridge 152S2 accommodates the developer G containing the new toner T of the second special color (S2) and a usual number of carriers CA. In this case, the supply path 154, the development device 100, and the photoreceptor 22 are continuously used.

Thereafter, although not shown, the developer G containing the toner T of the new second special color (S2) and the usual number of carriers CA is supplied from the developer cartridge 152S2 to the supply path 154, the development device 100, and the photoreceptor 22.

The discharge mode and the switch mode as described above are executed in a case where the developer cartridge 152S1 containing the toner T of the first special color (S1) is to be replaced with the developer cartridge 152S2 containing the toner T of the second special color (S2). However, the present disclosure is not limited thereto. For example, the discharge mode and the switch mode may be executed in a case where the developer cartridge 152 that contains the toner T of a normal color is to be replaced with a developer cartridge 152S that contains the toner T of a special color(S) and that is a replacement or a case where the developer cartridge 152S that contains the toner T of the special color(S) is to be replaced with the developer cartridge 152 that contains a toner of a normal color and that is a replacement.

### Problem of Image Forming System in Comparative Example

Here, the problem of an image forming system in a comparative example will be described.

In a case of forming an image by means of toner having a special color, the characteristics such as the particle diameter of the toner having a special color differs depending on the type of the toner. The image forming system in a comparative example includes a charging roll that charges a surface of a photoreceptor. The charging roll charges a surface of the photoreceptor by applying a voltage obtained by superimposing an AC voltage on a DC voltage. In the image forming system including the charging roll, since the surface of the photoreceptor is roughened by corona products, a cleaning member is affected by the toner and the degree of vibration is increased, so that a cleaning failure is likely to occur. Therefore, in a case where the toner having a special color is to be replaced with toner having another special color at the same position with respect to the photoreceptor, all of a developer cartridge, a supply path, a development device, and the photoreceptor are replaced. Therefore, there is a problem that the developer cartridge, the supply path, the development device, and the photoreceptor cannot be frequently replaced, and it takes time and effort to perform replacement.

### Action of First Exemplary Embodiment

Next, the action of the image forming system 10 of the first exemplary embodiment will be described.

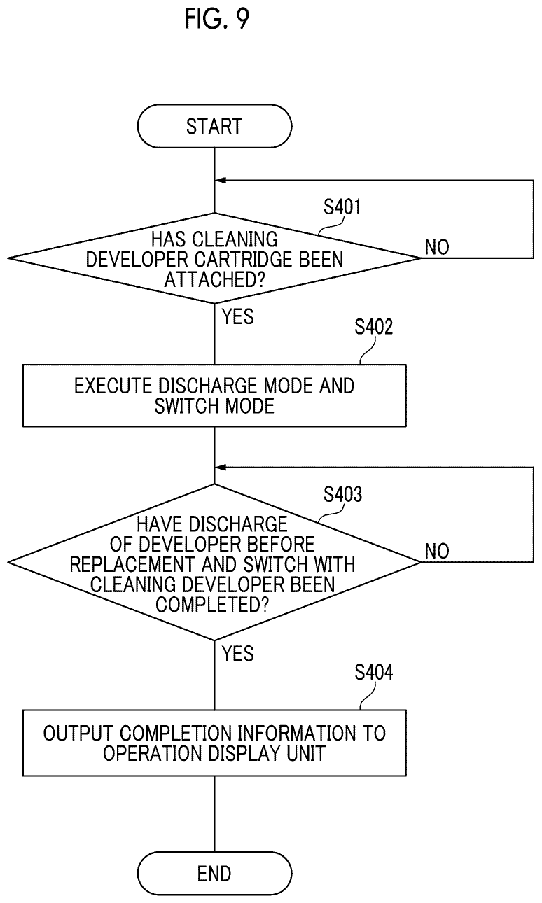

FIG. 9 is a flowchart showing the flow of information processing that the image forming system 10 of the first exemplary embodiment takes charge of. In the image forming system 10, the CPU 211 reads out a processing program from the ROM 212 or the storage 214, loads the processing program into the RAM 213, and executes the processing program so that processing is performed.

The CPU 211 determines whether or not the cleaning developer cartridge has been attached to the supply path 154 (step S401). For example, the CPU 211 determines whether or not the cleaning developer cartridge 182S2 accommodating the cleaning developer G2 that contains the toner T of the special color (S2) and a larger number of carriers CA than usual has been attached to the supply path 154 (refer to FIGS. 6 and 7). Whether or not the cleaning developer cartridge 182S2 has been attached to the supply path 154 can be detected by a sensor (not shown).

In a case where the cleaning developer cartridge has not been attached to the supply path 154 (step S401: NO), the CPU 211 stands by until the cleaning developer cartridge is attached to the supply path 154.

In a case where the cleaning developer cartridge has been attached to the supply path 154 (step S401: YES), the CPU 211 executes the discharge mode and the switch mode (step S402). For example, the CPU 211 causes the image forming unit driving unit 221, the development device driving unit 223, and the developer supply driving unit 224 to operate, so that the discharge mode and the switch mode are executed. For example, in the discharge mode, the cleaning developer G2 is supplied from the cleaning developer cartridge 182S2 and thus the developer G before replacement that is in the supply path 154 and the development device 100 is discharged (refer to FIG. 6). In addition, for example, in the switch mode, the developer in the supply path 154 and the development device 100 is switched with the cleaning developer G2 (refer to FIG. 6). For example, the CPU 211 progresses the discharge mode and the switch mode simultaneously.

The CPU 211 determines whether or not discharge of the developer G before replacement and a switch with the cleaning developer G2 have been completed (step S403). For example, the developer sensor 226 provided in the development device 100 detects that the discharge of the developer G before replacement and the switch with the cleaning developer G2 have been completed.

In a case where the discharge of the developer G before replacement and the switch with the cleaning developer G2 have not been completed (step S403: NO), the CPU 211 stands by until the discharge of the developer G before replacement and the switch with the cleaning developer G2 are completed.

In a case where the discharge of the developer G before replacement and the switch with the cleaning developer G2 have been completed (step S403: YES), the CPU 211 outputs completion information to the operation display unit 225 (step S404). Accordingly, processing based on a processing program that the image forming system 10 takes charge of ends.

In the above-described image forming system 10, in a case where the cleaning developer cartridge 182S2 is attached to the supply path 154, the CPU 211 executes the discharge mode in which the cleaning developer G2 is supplied so that the developer G before replacement that is in the supply path 154 and the development device 100 is discharged and the switch mode in which the developer in the supply path 154 and the development device 100 is switched with the cleaning developer G2. The cleaning developer cartridge 182S2 accommodates the cleaning developer G2 that is a replacement and that contains the toner T of the second special color S2, which is a new color, and a larger number of carriers CA than a usual number of carriers CA.

Therefore, in the image forming system 10, for example, in a case where the developer cartridge 152S1 is to be replaced with another developer cartridge 152S2 accommodating the developer G containing the toner T of a different color, it is not necessary to replace, as members other than the developer cartridge 152S1, the supply path 154 and the development device 100 at least.

In addition, the CPU 211 progresses the discharge mode and the switch mode simultaneously. Therefore, in the image forming system 10, the developer G before replacement that is in the supply path 154 and the development device 100 may be smoothly switched with the cleaning developer G2 in comparison with the discharge mode and the switch mode are executed sequentially. Furthermore, the developer G before replacement that is in the supply path 154 and the development device 100 may be switched with the cleaning developer G2 within a short time in comparison with the discharge mode and the switch mode are executed sequentially.

In addition, the image forming system 10 has a configuration in which the supply path 154, the development device 100, and the photoreceptor 22 are continuously used in a case where the cleaning developer cartridge 182S2 is attached to the supply path 154. Therefore, in the image forming system 10, for example, in a case where the developer cartridge 152S1 is to be replaced with another developer cartridge 152S2 accommodating the developer G containing the toner T of a different color, it is not necessary to replace the supply path 154, the development device 100, and the photoreceptor 22.

In addition, in the image forming system 10, the charging roll 24 that charges a surface of the photoreceptor 22 by applying a voltage obtained by superimposing an AC voltage on a DC voltage is provided upstream of the development device 100 in the rotation direction of the photoreceptor 22. Therefore, in the image forming system 10, the photoreceptor 22 may be continuously used even in the case of a configuration in which the number of corona products on the surface of the photoreceptor 22 is likely to increase due to the charging roll 24.

In addition, the image forming system 10 has a configuration in which, after the developer in the supply path 154 and the development device 100 is switched with the cleaning developer G2, the cleaning developer cartridge 182S2 is replaced with the developer cartridge 152S2 that accommodates the toner T of the second special color S2 and a usual number of carriers CA and that is a replacement, the second special color being a new color. Therefore, in the image forming system 10, the image quality is stabilized as compared with a case where the cleaning developer cartridge is used as it is during image formation.

In addition, the image forming system 10 has a configuration in which the supply path 154, the development device 100, and the photoreceptor 22 are continuously used in a case where the cleaning developer cartridge 182S2 is replaced with the developer cartridge 152S2 that is a replacement. Therefore, in the image forming system 10, it is not necessary to replace the supply path 154, the development device 100, and the photoreceptor 22.

In addition, in the image forming system 10, the discharge mode and the switch mode are executed in a case where the developer cartridge 152S1 that contains the toner T of the first special color S1 is to be replaced with the developer cartridge 152S2 that contains the toner T of the second special color S2 and that is a replacement, the second special color S2 being a different color. Therefore, in the image forming system 10, in a case where the developer cartridge 152S1 is to be replaced with another developer cartridge 152S2 accommodating the developer G containing the toner T of a different color, it is not necessary to replace, as members other than the developer cartridge 152S1, the supply path 154 and the development device 100 at least.

In addition, the cleaning developer cartridge 182S2 accommodates the carriers CA that are equal to or more than two times a usual number of carriers CA inside the developer cartridge 152S1 in terms of weight ratio. Accordingly, the toner T of the second special color S2 is likely to be attracted to the carriers CA and the developer G before replacement is easily discharged by means of supply of the cleaning developer G2. Therefore, in the image forming system 10, the developer G before replacement is easily switched with the cleaning developer G2 in comparison with a case where the cleaning developer cartridge accommodates carriers that are smaller than two times a usual number of carriers in the developer cartridge in terms of weight ratio.

In addition, the discharge mode includes an operation of causing, by means of rotation of the photoreceptor 22, the toner T from the development device 100 to adhere to a surface of the photoreceptor 22 to form a toner image 320 and cleaning the surface of the photoreceptor 22 by means of the cleaning blade 28A and the cleaning brush 28B. Therefore, in the image forming system 10, the toner image 320 formed on the surface of the photoreceptor 22 is removed by the cleaning blade 28A and the cleaning brush 28B and thus the developer G before replacement may be quickly discharged.

In addition, the toner image 320 is formed up to the outside of an area through which the paper sheet P passes with respect to the photoreceptor 22. Therefore, in the image forming system 10, discharge of the developer G before replacement is completed early in comparison with a case where a toner image is formed within the area through which the paper sheet P passes.

In addition, the toner image 320 is a halftone toner image of which the coverage rate is equal to or greater than 30% and equal to or smaller than 60%. Therefore, in the image forming system 10, long-time discharge of the developer G before replacement is suppressed in comparison with a case where a halftone toner image of which the coverage rate is smaller than 30% is formed. In addition, clogging that is caused by toner in a case where the toner image 320 removed by the cleaning blade 28A and the cleaning brush 28B is collected is suppressed in comparison with a case where a halftone toner image of which the coverage rate is greater than 60% is formed.

In addition, in the case of the developer replacement method in the image forming system 10, the cleaning developer cartridge 182S2 accommodating the cleaning developer G2 that is a replacement and that contains the toner T of the second special color S2 and a larger number of carriers CA than a usual number of carriers CA is attached to the supply path 154. Furthermore, the cleaning developer G2 is supplied from the cleaning developer cartridge 182S2 so that the developer G before replacement that is in the supply path 154 and the development device 100 is discharged and the developer in the supply path 154 and the development device 100 is switched with the cleaning developer G2. Therefore, with the developer replacement method, in a case where the developer cartridge 152S1 is to be replaced with another developer cartridge 152S2 accommodating the developer G containing the toner T of a different color, it is not necessary to replace, as members other than the developer cartridge 152S1, the supply path 154 and the development device 100 at least.

In addition, in the case of the developer replacement method, the photoreceptor 22, the development device 100, and the supply path 154 are continuously used in a case where the cleaning developer cartridge 182S2 is attached to the supply path 154. Therefore, with the developer replacement method, in a case where the developer cartridge 152S1 is to be replaced with another developer cartridge 152S2 accommodating the developer G containing the toner T of a different color, it is not necessary to replace the supply path 154, the development device 100, and the photoreceptor 22.

In addition, in the case of the developer replacement method, after the developer in the supply path 154 and the development device 100 is switched with the cleaning developer G2, the cleaning developer cartridge 182S2 is replaced with the developer cartridge 152S2 that accommodates the toner T of a new color and a usual number of carriers CA and that is a replacement. Therefore, with the developer replacement method, the image quality is stabilized in comparison with a case where the cleaning developer cartridge is used without being replaced in the case of image formation.

In addition, in the case of the developer replacement method, the supply path 154, the development device 100, and the photoreceptor 22 are continuously used in a case where the cleaning developer cartridge 182S2 is replaced with the developer cartridge 152S2 that is a replacement. Therefore, with the developer replacement method, it is not necessary to replace the supply path 154, the development device 100, and the photoreceptor 22.

In addition, the cleaning developer cartridge 182S2 accommodates the cleaning developer G2 that contains the toner T of the second special color S2 and a larger number of carriers CA than a usual number of carriers CA accommodated in the developer cartridge 152. Therefore, the developer G in the supply path 154 and the development device 100 may be discharged and replaced with the cleaning developer G2 by means of the cleaning developer cartridge 182S2.

### Supplementary Description

The image forming system according to the exemplary embodiment of the present disclosure is not limited to the image forming system 10 described in the first exemplary embodiment, and various modifications can be made. For example, the configuration of the development device 100 or the configuration of the supply path 154 can be changed.

In addition, processing in the image forming system 10 can also be realized by a dedicated hardware circuit. In this case, the processing may be executed by one piece of hardware or may be executed by a plurality of pieces of hardware.

In addition, a program for operation of the image forming system 10 may be provided by a computer-readable recording medium such as a Universal Serial Bus (USB) memory, a flexible disk, or a Compact Disc Read Only Memory (CD-ROM), or may be provided online via a network such as the Internet. In this case, the program recorded on the computer-readable recording medium is usually transferred to a memory, a storage, or the like and stored. In addition, for example, the program may be provided as independent application software, or may be incorporated into software of each device as a function of the image forming system 10.

Note that, although a specific exemplary embodiment of the present invention has been described in detail, the present invention is not limited to the exemplary embodiment and it is obvious to persons skilled in the art that other various exemplary embodiments are possible without departing from the scope of the present invention.

### Supplementary Note

Hereinafter, aspects of the present disclosure will be additionally described.

(((1)))

An image forming system comprising:
a plurality of photoreceptors with surfaces on which electrostatic latent images attributable to a difference in charging potential are formed;
a plurality of development devices that are provided to face the photoreceptors, that respectively accommodate toners of different colors, and that develop the electrostatic latent images by means of the toners;
a plurality of developer accommodation portions that accommodate developers of different colors each of which contains a toner of a normal color, which is any one of yellow, magenta, cyan, or black, or a toner of a special color other than the normal color and a carrier;
a plurality of supply paths through which the developers from the developer accommodation portions are respectively supplied to the development devices; and
at least one processor configured to execute
   a discharge mode in which, in a case where a cleaning developer accommodation portion accommodating a cleaning developer that is a replacement and that contains a toner of a new color and a larger number of carriers than a usual number of carriers is attached to a supply path, the cleaning developer is supplied so that a developer before replacement that is in the supply path and a development device is discharged, and
   a switch mode in which the developer in the supply path and the development device is switched with the cleaning developer.
      (((2)))

The image forming system according to (((1))),
wherein the processor is configured to simultaneously progress the discharge mode and the switch mode.
   (((3)))

The image forming system according to (((1))) or (((2))),
wherein the supply path, the development device, and a photoreceptor are continuously used in a case where the cleaning developer accommodation portion is attached to the supply path.
   (((4)))

The image forming system according to any one of (((1) to 3))), further comprising:
a charging roll that is provided upstream of the development device in a rotation direction of a photoreceptor and that charges a surface of the photoreceptor by applying a voltage obtained by superimposing an AC voltage on a DC voltage.
   (((5)))

The image forming system according to any one of (((1))) to (((4))),
wherein, after the developer in the supply path and the development device is switched with the cleaning developer, the cleaning developer accommodation portion is replaced with a developer accommodation portion that accommodates a toner of the new color and a usual number of carriers and that is a replacement.
   (((6)))
The image forming system according to (((5))),
wherein the supply path, the development device, and a photoreceptor are continuously used in a case where the cleaning developer accommodation portion is replaced with the developer accommodation portion that is the replacement.
   (((7)))
The image forming system according to any one of (((1))) to (6)
wherein the discharge mode and the switch mode are executed in a case where a developer accommodation portion that contains a toner of the normal color is to be replaced with a developer accommodation portion that contains a toner of the special color and that is a replacement, a case where the developer accommodation portion that contains the toner of the special color is to be replaced with the developer accommodation portion that contains the toner of the normal color and that is a replacement, or a case where the developer accommodation portion that contains the toner of the special color is to be replaced with a developer accommodation portion that contains a toner of a different special color and that is a replacement.
   (((8)))
The image forming system according to any one of (((1))) to (7)
wherein the cleaning developer accommodation portion accommodates carriers that are equal to or more than two times a usual number of carriers inside a developer accommodation portion in terms of weight ratio.
   (((9)))
The image forming system according to any one of (((1))) to (((8))),
wherein the discharge mode includes an operation of causing, by means of rotation of a photoreceptor, a toner from the development device to adhere to a surface of the photoreceptor to form a toner image and cleaning the surface of the photoreceptor by means of a cleaning member.
   (((10)))
The image forming system according to (((9))),
wherein the toner image is formed up to an outside of an area through which a recording medium passes with respect to the photoreceptor.
   (((11)))
The image forming system according to (((9))) or (((10))),
wherein the toner image is a halftone toner image of which a coverage rate is equal to or greater than 30% and equal to or smaller than 60%.
   (((12)))
A developer replacement method for an image forming system including a plurality of photoreceptors with surfaces on which electrostatic latent images attributable to a difference in charging potential are formed, a plurality of development devices that are provided to face the photoreceptors, that respectively accommodate toners of different colors, and that develop the electrostatic latent images by means of the toners, a plurality of developer accommodation portions that accommodate developers of different colors each of which contains a toner of a normal color, which is any one of yellow, magenta, cyan, or black, or a toner of a special color other than the normal color and a carrier, and a plurality of supply paths through which the developers from the developer accommodation portions are respectively supplied to the development devices, the method comprising:
attaching a cleaning developer accommodation portion accommodating a cleaning developer that is a replacement and that contains a toner of a new color and a larger number of carriers than a usual number of carriers to a supply path so as to supply the cleaning developer so that a developer before replacement that is in the supply path and a development device is discharged, and
switching the developer in the supply path and the development device with the cleaning developer.
   (((13)))
The developer replacement method according to (((12))),
wherein a photoreceptor, the development device, and the supply path are continuously used in a case where the cleaning developer accommodation portion is attached to the supply path.
   (((14)))
The developer replacement method according to (((12))) or (((13))),
wherein, after the developer in the supply path and the development device is switched with the cleaning developer, the cleaning developer accommodation portion is replaced with a developer accommodation portion that accommodates a toner of the new color and a usual number of carriers and that is a replacement.
   (((15)))
The developer replacement method according to (((14))),
wherein the supply path, the development device, and a photoreceptor are continuously used in a case where the cleaning developer accommodation portion is replaced with the developer accommodation portion that is the replacement.
   (((16)))
A cleaning developer accommodation portion accommodating a cleaning developer that is a replacement and that contains a toner of a new color and a larger number of carriers than a usual number of carriers accommodated in a developer accommodation portion.
In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.
The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
a plurality of photoreceptors with surfaces on which electrostatic latent images attributable to a difference in charging potential are formed;
a plurality of development devices that are provided to face the photoreceptors, that respectively accommodate toners of different colors, and that develop the electrostatic latent images by means of the toners;
a plurality of developer accommodation portions that accommodate developers of different colors each of which contains a toner of a normal color, which is any one of yellow, magenta, cyan, or black, or a toner of a special color other than the normal color and a carrier;
a plurality of supply paths through which the developers from the developer accommodation portions are respectively supplied to the development devices; and
at least one processor configured to execute
a discharge mode in which, in a case where a cleaning developer accommodation portion accommodating a cleaning developer that is a replacement and that contains a toner of a new color and a larger number of carriers than a usual number of carriers is attached to a supply path, the cleaning developer is supplied so that a developer before replacement that is in the supply path and a development device is discharged, and
a switch mode in which the developer in the supply path and the development device is switched with the cleaning developer.

2. The image forming system according to claim 1,
wherein the processor is configured to simultaneously progress the discharge mode and the switch mode.

3. The image forming system according to claim 1,
wherein the supply path, the development device, and a photoreceptor are continuously used in a case where the cleaning developer accommodation portion is attached to the supply path.

4. The image forming system according to claim 1, further comprising:
a charging roll that is provided upstream of the development device in a rotation direction of a photoreceptor and that charges a surface of the photoreceptor by applying a voltage obtained by superimposing an AC voltage on a DC voltage.

5. The image forming system according to claim 1,
wherein, after the developer in the supply path and the development device is switched with the cleaning developer, the cleaning developer accommodation portion is replaced with a developer accommodation portion that accommodates a toner of the new color and a usual number of carriers and that is a replacement.

6. The image forming system according to claim 5,
wherein, the supply path, the development device, and a photoreceptor are continuously used in a case where the cleaning developer accommodation portion is replaced with the developer accommodation portion that is the replacement.

7. The image forming system according to claim 1,
wherein the discharge mode and the switch mode are executed in a case where a developer accommodation portion that contains a toner of the normal color is to be replaced with a developer accommodation portion that contains a toner of the special color and that is a replacement, a case where the developer accommodation portion that contains the toner of the special color is to be replaced with the developer accommodation portion that contains the toner of the normal color and that is a replacement, or a case where the developer accommodation portion that contains the toner of the special color is to be replaced with a developer accommodation portion that contains a toner of a different special color and that is a replacement.

8. The image forming system according to claim 1,
wherein the cleaning developer accommodation portion accommodates carriers that are equal to or more than two times a usual number of carriers inside a developer accommodation portion in terms of weight ratio.

9. The image forming system according to claim 1,
wherein the discharge mode includes an operation of causing, by means of rotation of a photoreceptor, a toner from the development device to adhere to a surface of the photoreceptor to form a toner image and cleaning the surface of the photoreceptor by means of a cleaning member.

10. The image forming system according to claim 9,
wherein the toner image is formed up to an outside of an area through which a recording medium passes with respect to the photoreceptor.

11. The image forming system according to claim 9,
wherein the toner image is a halftone toner image of which a coverage rate is equal to or greater than 30% and equal to or smaller than 60%.

12. A developer replacement method for an image forming system including a plurality of photoreceptors with surfaces on which electrostatic latent images attributable to a difference in charging potential are formed, a plurality of development devices that are provided to face the photoreceptors, that respectively accommodate toners of different colors, and that develop the electrostatic latent images by means of the toners, a plurality of developer accommodation portions that accommodate developers of different colors each of which contains a toner of a normal color, which is any one of yellow, magenta, cyan, or black, or a toner of a special color other than the normal color and a carrier, and a plurality of supply paths through which the developers from the developer accommodation portions are respectively supplied to the development devices, the method comprising:
attaching a cleaning developer accommodation portion accommodating a cleaning developer that is a replacement and that contains a toner of a new color and a larger number of carriers than a usual number of carriers to a supply path so as to supply the cleaning developer so that a developer before replacement that is in the supply path and a development device is discharged, and
switching the developer in the supply path and the development device with the cleaning developer.

13. The developer replacement method according to claim 12,
wherein a photoreceptor, the development device, and the supply path are continuously used in a case where the cleaning developer accommodation portion is attached to the supply path.

14. The developer replacement method according to claim 12,
wherein, after the developer in the supply path and the development device is switched with the cleaning developer, the cleaning developer accommodation portion is replaced with a developer accommodation portion that accommodates a toner of the new color and a usual number of carriers and that is a replacement.

15. The developer replacement method according to claim 14,
wherein the supply path, the development device, and a photoreceptor are continuously used in a case where the cleaning developer accommodation portion is replaced with the developer accommodation portion that is the replacement.

16. A cleaning developer accommodation portion accommodating a cleaning developer that contains a toner of a specific color and a larger number of carriers than a usual number of carriers accommodated in a developer accommodation portion.
